(19) United States
(12) Patent Application Publication
(10) Pub. No.: US 2012/0256082 A1
(43) Pub. Date: Oct. 11, 2012

(54) PHASE SHIFT RF ION TRAP DEVICE

(75) Inventors: Tsutomu Masujima, Hiroshima (JP); Gary Abdiel Salazar, Hiroshima (JP)

(73) Assignee: HIROSHIMA UNIVERSITY, Minami-ku (JP)

(21) Appl. No.: 11/743,559

(22) Filed: May 2, 2007

(51) Int. Cl. H01J 49/36

(52) U.S. Cl. 250/282; 250/290

(57) ABSTRACT

A novel ion trap made of at least two ion guides sets separated by a gap and each guide consists of three or more rods-like multipole carrying radio frequency (RF) voltages with delayed phases. The injected ions are axially or orthogonally, contained by pulsed DC and/or RF voltages. When the ions translational energy is damped due to collisions with a low-pressurized inert gas, the 3-D RF field in the gap, which is created by the special rod and electricity arrangement, can trap the ions and compact them in a dense ion cloud. Because the ions are trapped in the small gap, new ions can be injected and the trapping cycle can be repeated many times before the ion ejection. The ions are ejected from the gap orthogonally or axially. This ion trap is useful for mass spectrometry and beam physics, specifically for high efficient ion accumulation and focusing the ions in a small space.

### BACKGROUND OF THE INVENTION

1. Field of the Invention

This invention relates to ion trap devices, more particularly, to such devices that are formed by three or more electrode rods ion guide with phase shifted RF voltages.

2. Description of the Related Art

Multipole ion guides have been used in mass spectrometry to contain the ions in radial direction by means of RF electric fields, where the ions stably oscillate and fly through the system, thus the ions are transported to the different stages of the spectrometer. Traditionally, the multipole ion guides have been used to construct linear ion traps (LIT) by adding entrance and exit ion optics to the ion guide, thereby axial trapping is accomplished.

In bio-analytical sciences, high sensitivity is a key point for success. The signal-to-noise ratio can be considerably increased by analyte accumulation inside of a LIT that is a high sensitive and widely used mass spectrometry technique. The LIT is considered to have higher trapping efficiency and sensitivity than the conventional 3D quadrupole ion trap (QIT or Paul Trap). The trapping efficiency for LIT increases up to 100% compared with the 5% range for QIT when high-speed ions are externally injected. When many ions are accumulated, space-charge repulsion interferes with trapping more ions and, in some cases, expulses some ions. Because LIT volume is bigger than the QIT volume then space-charge repulsion is reduced in LIT. However, even the newest and conventional linear ion traps share one disadvantage: Before ion ejection and detection, the trap can be filled only during a short time-lapse. After this time-lapse, some ions escape when return to the entrance. Thus, ion accumulation is limited by the ion speed and the length of the trap.

A segmented LIT and ring electrode trap are exceptions because they compartmentalize the first ion bunch in one or more segments and then a new bunch can enter. However, the segmented LIT does not use phase shift RF voltage and does not trap ions in the gap. Further, its construction is complicated and expensive due to its inherent multiple sections, segments mounting, RF and DC voltage supply. Another weak point for LIT, working as ion source for a mass analyzer, is that the ion ejection of the axially dispersed beam is not always completely effective. Also linear ion traps made of multipoles are difficult to mount due to the number and proximity of the rod electrodes.

### SUMMARY OF THE INVENTION

An ion trap comprises at least two ion guides separated by one or more gaps and each ion guide comprises three or more (“n”) electrodes that are numbered “E” consecutively clockwise or counterclockwise from 1 to “n”. Entrance ion optics is provided at one end of the ion trap. Exit ion optics is provided at the other end of the ion trap. At least one voltage supply is provided to feed the electrodes, the entrance ion optics, and the exit optics, wherein each of the electrodes is applied with phase-delayed RF voltage for trapping an electrically charged particle or an ion in the ion trap.

In this configuration, ions can be injected from an axial direction and/or an orthogonal direction with respect to the longitudinal axis, contained by an electrical field, and ejected in an axial direction and/or an orthogonal direction with respect to the longitudinal axis. Because the ions are trapped in the small gap, new ions can be injected and the trapping cycle can be repeated.

In another embodiment of the present invention, an ion trap comprises three or more electrodes positioned around a central axis and at least one voltage supply to feed the electrodes with an RF voltage, wherein a field radius decreases from a trap center to longitudinal ends of the ion trap in a longitudinal direction.

In another embodiment of the present invention, an ion trap comprises two or more ion guides separated by a gap and constituting the ion trap in a continual shape where each of the ion guides comprising at least three or more electrodes, and at least one voltage supply adapted to apply the electrodes with phase-delayed RF voltage that traps an electrically charged particle in the ion trap.

### BRIEF DESCRIPTION OF THE DRAWINGS

Embodiments of the claimed invention together with its various features and advantages, can be readily understood from the following more detailed description taken in conjunction with the accompanying drawings, in which:

FIG. 1 illustrates a perspective view of a three-dimensional view of a tripole linear ion trap.

FIG. 2A illustrates a cross section view of the tripole linear trap.

FIG. 2B illustrates a side view of the linear trap with guides of n=3 (tripole).

FIG. 2C illustrates an upper view of the tripole trap.

FIG. 3A-D illustrate a cross section view of the scheme of the trap when both guides are symmetric and identical.

FIG. 3A illustrates a trap with guides of n=4.

FIG. 3B illustrates a trap with guides of n=5.

FIG. 3C illustrates a trap with guides of n=7.

FIG. 3D illustrates a trap with guides of n=8.

FIG. 3E-F illustrate a cross section view of the scheme of the trap when the positioning of one guide is rotated relative to the other guide. The dotted circle represents the rods (E′) in one guide and the closed line represents the rods (E) in the other guide.

FIG. 3E illustrates a trap with one guide (n′=3) is rotated 60 degrees relative to the other guide (n=3).

FIG. 3F illustrates a trap where both guides have different number of rods, wherein one guide (n=3) is rotated 60 degrees relative to the other guide (n′=4).

FIG. 4 illustrates a perspective view of the entrance aperture plate and the tripole.

FIG. 5 illustrates a perspective view of the exit aperture plate and the tripole.

FIG. 6 illustrates a perspective view of the gap space.

FIG. 7A shows AC or RF voltages applied to the rod electrodes of the tripole trap.

FIG. 7B shows RF voltages applied to “n” rod electrodes used in each ion guide.

FIG. 7C shows square RF voltages applied to the rod electrodes of the tripole trap.

FIG. 8 illustrates SIMION computer simulation of the ion rotation and oscillations trajectories.

FIG. 9A illustrates a side view of the axial ion injection.

FIG. 9B illustrates a side view of the ion-gas collisions and gap ion trapping.

FIG. 9C illustrates the pulse voltage applied to the entrance and exit optics for axial trapping in the positive mode.

FIG. 9D illustrates the pulse voltage applied to the entrance and exit optics for axial trapping in the negative mode.

FIG. 9E shows pseudo-potential in the gap space.

FIG. 10A shows synchronized square voltage applied to the entrance, exit and the tripole ion guide offset.

FIG. 10B illustrates the axial trapping as result of the synchronized square voltages.

FIG. 10C illustrates orthogonal and axial ejection by synchronized square voltages.

FIG. 11A shows computer simulation of the ion trajectory inside of the tripole trap when the ion is axially trap in the gap space.

FIG. 11B shows computer simulation of the ion trajectory inside of a conventional quadrupole linear ion trap with a gap and without rotating RF voltage. The ion is axially trap but is not contained in the gap space.

FIG. 11C illustrates computer simulation of the ejection of the ions trapped in the tripole gap space in the direction perpendicular to the longitudinal axis.

FIG. 11D illustrates computer simulation of the ejection of the ions trapped in the tripole gap space in the axial direction.

FIG. 12A shows computer simulation results of the tripole trap and quadrupole LIT total trapping efficiency as a function of the beam density (charge repulsion) increases.

FIG. 12B shows computer simulation result of the ion position distribution around the gap center after a trapping time of 1 ms inside a tripole trap and a quadrupole LIT.

FIG. 12C shows computer simulation of the ion radial position inside the tripole gap after 1 ms trapping time.

FIG. 12D simulation result of 500 ions in percentage of trapped ions in the whole tripole trap and the tripole gap space as a function of time.

FIG. 13A shows computer simulation (3D and transversal view) of quadrupole ion trapping in the gap with phase delay or rotating RF voltage.

FIG. 13B shows computer simulation (3D and transversal view) of hexapole ion trapping in the gap with phase delay or rotating RF voltage.

FIG. 13C shows simulation result of 500 ions in percentage of trapped ions in the whole quadrupole RF phase shift trap and in its gap space as a function of time.

FIG. 14A illustrates additional electrodes enclosing the tripole gap for enhancing the trapping efficiency and the axial ejection.

FIG. 14B illustrates computer simulation of the ion ejection by applying pulse voltage to the rod electrode opposite to the ejection trajectory, while the other electrodes are grounded.

FIG. 14C illustrates computer simulation of the ion ejection by applying pulse voltage to the rod electrode opposite to the ejection trajectory and lower magnitude pulse voltage is applied to the other rods.

FIG. 14D illustrates a perspective view of the ion trap having additional electrodes enclosing the phase shift RF trap, in this case wires at angular positions intercalated between each of the phase shift RF rods.

FIG. 15A illustrates ion trapped in the tripole gap, not excited due to the low voltage.

FIG. 15B illustrates ion amplitude and speed excited by the increase of the RF voltage amplitude. This increases the number and kinetic energy of collisions with background gas.

FIG. 15C illustrates ion fragmented due to the high amount of energy absorbed due to the high number of energetic collisions with background gas.

FIG. 15D show RF amplitude corresponding to FIGS. 15A-15C.

FIG. 16A shows computer simulation result of ion relative speed for an ion excited by RF amplitude pulse and without excitation.

FIG. 16B shows computer simulation of ion survival yield for an ion excited by RF amplitude pulse and without excitation.

FIG. 17A illustrates the linear acceleration of the ion in the tripole trap working as CID collision cell.

FIG. 17B illustrates precursor ions that are fragmented and the fragments that are accumulated in the gap.

FIG. 17C shows computer simulation result of the ion survival yield when the acceleration voltage is increased in the tripole and quadrupole LIT for brandykinin²⁺.

FIG. 17D shows computer simulation result of the ion survival yield when the acceleration voltage is increased in the tripole and quadrupole LIT for brandykinin³⁺.

FIG. 18A illustrates a perspective view of the tripole trap with ions illuminated, excited and fragmented by laser methods or by particle-particle reaction such as ECD, ETD, “in-trap” EI and “in-trap” CI.

FIG. 18B illustrates a transversal view of the tripole trap with ions illuminated, excited and fragmented by the same methods as in FIG. 18A.

FIG. 19A illustrates a transversal view of computer simulation trajectory of ions internally ionised in the phase shift RF gap by a laser introduced through a hole in the electrode. The enclosing circular electrode is grounded, so the trapping efficiency is low.

FIG. 19B illustrates a transversal view of computer simulation trajectory of ions internally ionised in the phase shift RF gap by a laser introduced through a hole in the electrode. The enclosing electrode has low DC voltage and the sample drop is in a tip shape non-conductive stage.

FIG. 19C illustrates an axial transversal view of computer simulation trajectory of ions internally ionised in the phase shift RF gap by a laser introduced through a hole in the electrode. The enclosing electrode has low DC voltage.

FIG. 19D illustrates a transversal view of the phase shift RF gap, in this case quadrupole, enclosed in a circular electrode. The neutral sample is injected through an electricity isolated pipe and internally ionised by a laser or any other method.

FIG. 20A illustrates non parallel (tilted) trap rods.

FIG. 20B illustrates the rods having angle cut near the gap space.

FIG. 20C illustrates the rods having angle cut near the gap space.

FIG. 21A illustrates a scheme of the trap, which comprises of a phase-shifted RF guide, with entrance and exit ion optics, and the gap can be eliminated. The rod can be shaped in any form, in this case, it is oval.

FIG. 21B shows computer simulation (3D view) of the ion trap illustrated in FIG. 21A.

FIG. 21C shows results of ion count as a function of the axial position in the ion trap illustrated in FIG. 21A.

FIG. 21D shows computer simulation (3D view) of the ion trap illustrated in FIG. 21A.

FIG. 22A illustrates a segmented phase shift RF trap of a tripole.

FIG. 22B illustrates a segmented phase shift RF trap of a pentapole.

FIG. 22C illustrates an upper view of a ring-shape RF rotating trap.

FIG. 22D illustrates a perspective view of a ring-shape RF rotating trap.

FIG. 23A illustrates a front view of a RF phase shift micropole array, in this case tripole array for a miniature mass spectrometer. The RF voltage is supplied thru a wire network overlapped for the three poles.

FIG. 23B illustrates a side view of the micropole array shown in FIG. 23A.

FIG. 24A illustrates a miniaturized RF phase shift trap of a planar symmetry tripole. The electrodes are made of stacked micro size conducting layers and separated by insulators.

FIG. 24B illustrates a side view of the planar symmetry RF rotating trap.

FIG. 25 illustrates an example scheme of the RF phase shift trap (center of the figure) connected to other ion optics, mass analysers and ion sources.

### DETAILED DESCRIPTION OF THE PREFERRED EMBODIMENTS

An embodiment of the present invention is an ion trap comprising at least two ion guides separated by one or more gaps and each ion guide comprises three or more (“n”) rod electrodes that are numbered “E” consecutively clockwise or counterclockwise from 1 to “n”.

The electrode is preferably in a rod shape. Each of the ion guides may have an equal or unequal number of electrodes. The rod electrodes are positioned in radial locations around a field space. The electrodes can be asymmetrically or symmetrically positioned at angular position (θ), where θ_{E}=2π(E−1)/n radian is determined with a central axis as the origin. In the case of asymmetric angular positioning, the rods width and shape preferably be changed in order to fulfil two conditions, the electrodes with different phase cannot touch each other and the electrodes may surround the field space. In the case of three-rod electrodes in a symmetrical position, the rods are positioned at angular positions of 0, 120 and 240 degrees.

The rod electrodes carry three or more (“n”) number of RF voltages with delayed phase. The symmetric phase shift of each rod electrode may be calculated by φ_{E}=2π(E−1)/n radians and the phase shift between two consecutive rods is 2π/n radian. Furthermore, the phase shift can be asymmetric where the difference between two consecutives rods can be 0% to 200% or less, preferably, 50% to 150%, most preferably 75% to 125% of 2π/n. These special RF voltages create a rotating electric field where the ions stably rotate and oscillate. The phase shift RF voltages create a 3D-RF trapping field or a pseudopotential well in the gap. The RF voltage shape applied to the ion guides can be sinusoidal, square, pulse or any other kind of periodic electric voltage.

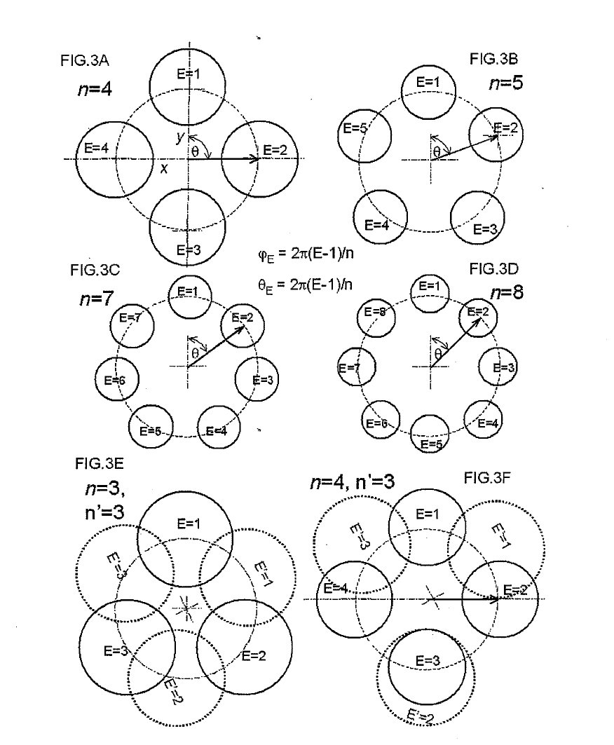

Rod electrodes that carry the same AC voltage and belong to different ion guides are called correspondent electrodes. The electrodes that face each other (same angular position) may not be correspondent electrodes. Correspondent electrodes angular position may differ in I2π/n radians; where n is the number of rods and I is an integer ranging from 0 to n, more preferably from 1 to n/2.5, and most preferably 1 to n/3. If the correspondent rods have the same angular position (wrong correspondent rods), the voltage difference between them always is nul along with the electric field in the space between them, creating a hole in the 3D field. In this case, many ions coming from the longitudinal center of the gap and flying in the angular direction of the wrong correspondent electrodes are lost. For example, using FIG. 3B, if two pentapole ion guides are used, I=integer(1.7), let's take I=1; and as consequence correspondent electrodes will differ 2π/n radians, so correspondent rods will be E1-E′2, E2-E′3, E3-E′4, E4-E′5, E5-E′1, where E and E′ refers to the electrode number in different guides. Also, this case works well for I=2.

The ion guide structure may or may not be the “mirror image” of the other one. When they are mirror image, they have the same number of rods, and each rod face a rod in the other ion guide. The non “mirror image” can be multiple options, such as when each rod in one ion guide doesn't face another rod in the second guide; their angular positions are shifted. Another example is when the number of rods are different in each ion guide, in this case the concept of correspondent rods doesn't apply. But one ion guide must be rotated over the central axis some radians the condition in order to follow the condition, electrodes facing each other may not carry the same RF phase shift.

The rod electrodes can be positioned by mounting and fixing the rods on ceramic, plastic or any other insulator. Material of the electrodes can be any electrically conducting or semiconductive material. Means of manufacturing and making the electrodes can be by molding, shaping, or any other method of the conductive material or covering a non-conductive material on the conductive material by means of any covering, deposition or coating method. A cross section perpendicular to a longitudinal direction of the rod electrode can be in any geometrical shape such as circle, square, rectangle, hyperbola, semicircle, semihyperbola, and flat plate. The rods can be symmetrically straight or curve in its longitudinal direction and positioned parallel or set at an angle relative to the central axis. The shape of the rod can also be tilted with respect to the longitudinal axis of the rod or conical or funnel-shaped to push the ions to the central gap.

A rod width is defined by twice the maximum distance from one periphery point, of the cross section of the rod to a symmetry center. In the case of circle shape of the rod cross section then the rod width is the diameter. A half of the rod width value is preferably between 0.2 to 4 times, more preferably between 1 to 3 times, and most preferably between 1.7 to 2.6 times of a field radius, where the field radius is the minimum distance from the trap longitudinal axis to the rod electrode surface. An axial length of a single electrode may be greater than 0% but 100% or less, preferably 30% to 70%, most preferably 40% to 60% of the length of the ion trap.

Entrance and exit ion optics are set at each ion trap outer edge. The ion optics may be an aperture plate, mass filters, ion traps, RF ion guides such as multipole or multi rings.

The system can also be miniaturized for portable instruments by arranging micropole arrays or microlithography.

A feature of the present invention consists in the gap in which a trapping 3D RF field is created. In an embodiment of the invention, an ion trap can be used as collision cell by linearly accelerating the ions or by pulsing the RF amplitude, accomplishing RF heating over the trapped ions. Also, an extra electrode can be set around the gap space, carrying DC voltage to prevent from losing some ions due to strong space charge repulsion and to help injecting and/or ejecting the ions.
1. Ion Injection

The ions can be confined linearly or longitudinally if a pulsed DC voltage is applied to the entrance and exit ion optics of the system, similarly as any LIT does, then the ions are trapped in all the directions (radial and axial). The entrance and exit ion optics are preferably centerd to the trap longitudinal axis and positioned from the entrance and exit edges respectively with a distance preferably ranging from 0% to 500%, more preferably 0% to 300%, and most preferably 0% to 100% of the field radius value where field radius (r₀) is the minimum distance from the trap longitudinal axis to the rod electrode surface. Field space is the circular space delimited by the field radius.

The entrance ion optics and the exit ion optics are applied with a voltage so as to create a pulsed electric field in a way that the electrically charged particle or the ion can pass through the entrance ion optics and become longitudinally trapped in the ion trap.

When the entrance voltage is grounded or with voltage opposite to the ion charge then the ions can enter. At the same time, the high voltage is applied to the exit ion optics thus the ions are reflected and change their flying direction, 180 degrees. After a lapse time (injection time), the entrance voltage is pulsed and the ions are trapped. The guiding RF field in the center of the phase shift RF trap is relatively higher than the flat and null guiding field in the center of all multipoles with opposite RF voltage. For this reason, the guiding field smoothly decreases in the longitudinal direction from the ion guide edge to the center of the gap. This longitudinal offset in combination with the radial guiding field, create a trapping 3D RF field.

A square pulse voltage or a mix of square pulses may be applied to the entrance ion optics. Depending on the ion charge, the entrance voltage becomes ground or negative, during a time-lapse (injection time), to allow positive ions to enter and vice verse for negative ions. For the exit ion optics, the square pulse voltage is opposite to the ion charge. After the injection time lapse, the entrance voltage is pulsed to negative or positive during a time lapse thus the electric field repels the ions and they become trapped inside of the guides. During the time when the voltage is pulsed, the ions are trapped linearly and longitudinally. The pulse voltage can also be applied to any of the phase shift RF guides as a bias voltage in order to linearly trap the ions. The entrance and exit optics voltage or the bias of the phase shift RF guides can be ground, DC, pulse, square, rectangular form, sinusoidal or any combination of the electricity forms.

A positive mode is when the entrance and exit voltage conditions are suitable to trap positive ions and negative mode is the vice verse situation. Both positive and negative ions can be trapped together when one of the trapping modes is used after the other mode has trapped ions. Positive and negative ions can be trapped sequentially or consecutively by using the trapping modes (trapping mode switching). Electron transfer disassociation (ETD) and any other neutral-ion, negative-positive ion reaction can be carried out and observed by means of trapping positive and negative ions using the trapping mode switching.

A neutral or externally ionised sample can be injected through a non-conducting pipe, orthogonally inserted between the rods in the gap space or in any other longitudinal position within the trap.
2. Gap Trapping

The ions collide with a neutral and inert gas pressurized inside of the trap and their kinetic energy is damped or reduced. When the ion speed is low enough, the ions are trapped and compacted in the gap by the trapping phase shift RF field. The RF voltage amplitude and/or frequency and/or phase shift order applied to the set of rods of one ion guide may be equal to or different from that applied to the set of rods of the other ion guide(s). The voltages create a 3D field that keeps the ions in the field space. The RF electric field makes a three-dimensional trapping field or a pseudopotential well or an effective potential in the gap space then after 1 or higher number of longitudinal turns, the ions kinetic energy is lowered, and then the ions become trapped and focused in the gap space.

Background gas can be used to minimize the ions radial and longitudinal speed in order to eject and deliver a high quality ion beam to a secondary analyzer. The shape of the phase shift RF rods and the additional electrodes help pushing the ions into the gap. The gap is the space between the guides and the length of the gap is defined by the longitudinal section, starting from the edge of one guide to another guide edge. The length of the gap is preferably in the range greater than 0% but 100% or less, more preferably greater than 0% but 50% or less, and most preferably greater than 5% 0% but 30% or less of the length of the rods. Alternatively, the length of the gap is preferably in the range greater than 0% but 500% or less, more preferably greater than 0% but 300% or less, and most preferably greater than 10% 0% but 200% 100% or less of the length of the field radius.

One or more additional electrode(s) or aperture plate(s) can be added around or near the gap. The additional electrode(s) can be in a substantially cylindrical shape and positioned partially or completely surrounding the gap, or enclosing the phase shift RF trap. The additional electrodes help to extract and keep collimated the orthogonally ejected ions when having DC voltage of opposite polarity of the ions. An axial length of the additional electrode may be in the range greater than 0% but 100% or less, preferably 5% to 80%, and more preferably 10% to 60% of the ion trap length.

The additional electrode(s) can also be wire(s) at angular positions intercalated between each of the phase shift RF rods. The wire(s) can have any azimuthal and elevation angle with symmetric or tapered shape. The additional electrode(s) prevents some ions from escaping the trap and/or the gap in the case of high ion density.

The RF ion trap may be provided with an electrode arrangement such as a ring-shaped pick-up electrode, a tube-shaped pick-up electrode, and a coil for inductively sensing the oscillations of the ions trapped in the gap. A frequency spectrum and a mass spectrum can be obtained using a detector that mirrors and detects the oscillation frequency and/or position of the trapped ions in the gap, coupled to a data acquisition system that obtain a mass spectrum by means of Fourier transformation and/or wavelet formation of the sensed ion oscillations.
3. Ion Accumulation

The ion injection and gap trapping processes can be repeated as many times as the user desires accumulating a high dense ion cloud (ion accumulation). During an accumulation time, because the ion trapping space and field are large, the charge repulsion is under control.

While the ions are trapped in the gap space, they can be observed and studied using any optical detection system. After the ions have been accumulated, they can be excited by radiant energy, or illuminated by UV, IR, any electromagnetic irradiating energy, temperature increase, or a combination of the foregoing and observed by lens sets, cameras, optical sensor and/or detectors. Another usage of the ion trap is for ion fragmentation induced by collisions with background gas, gas phase chemical reactions experiments, optics and physics studies of ion beams. For this kind of studies, the ions must be trapped and almost always must be immobilized in one point by means of collision damping and electric fields.

With or without changing the voltages in any electrode, these ions can be fragmented by external energy, particle-ion reaction, RF heating, collision induced fragmentation, or collision induced disassociation (CID). Examples of external energies are beams of electrons, atoms, ions, or photons, or any electromagnetic irradiation such as ultraviolet (UV), infrared multiphoton dissociation (IRMPD), Blackbody Infrared Radiative Dissociation (BIRD) or temperature increase. Examples of particle-ion reaction are electron-capture dissociation (ECD), electron transfer dissociation (ETD); or electron impact (EI) and chemical ionisation (CI), which are carried out inside the ion trap chamber (in-trap). “in-trap” EI and CI are carried out when the trapped ions are irradiated, ionised and excited with electron beams or ionised particles generated by means of a glow-discharge needle or a electron source, set in the trap chamber and near the gap. If the ions are not accelerated, the collisions damp or decrease the ion kinetic energy, accomplishing collisional cooling without fragmentation of the injected ions and the ion trap can be used as a collision cell and a focusing cell. When amplitude of the RF voltage of the ion trap is raised, speed and movement amplitude of the trapped ions can increase without losing any of the ions from the gap. As a result, CID increases and the ions may be fragmented by RF excitation. The RF ion trap can now be used as dissociation cell.
4. Ion Ejection

After an accumulation time, a simple system of an embodiment can easily eject the ions contained in the gap and in the whole trap by applying pulsed bias voltages to all the electrodes of at least one ion guide (longitudinal ejection). Specific electrode is applied with a voltage so as to create a pulsed electric field that eject the electrically charged particle or the ion contained in the ion trap. This can be achieved with or without turning off the RF voltages. the bias of one or more of the phase shift RF guides may be pulsed for an axial ejection.

The trapped ions can be radially ejected if pulse voltage is applied to the rod electrodes having the same angular position to push out the ions. A pulsed voltage may be applied to at least one phase shift RF rods of different ion guides to push out or eject the trapped ions orthogonally from the gap, with or without turning off the RF voltages.

When negative and positive ions are trapped, orthogonal ejection oppositely eject the negative and the positive ions, thus orthogonal ejection can be suitable for detecting or analysing both kinds of the ions.

Further, if pulse voltage, lower in magnitude than the pushing pulse, is applied to the other RF rods (non-pushing rods) then better ion focusing can be accomplished. The ejection can be more effective if additional and complicated electrodes are added to the system. Additional electrodes, preferably in a ring shape, may be set over the ejection axis in order to keep the beam focused. Because the ions have a narrow spread of energies before the ejection then the beam is energetically and spatially well focused. Well-focused beams are good for ion detection and mass resolution when a secondary analyzer is coupled to the ion trap. The trapped ions can also be soft-landed onto a surface for further use, further detection, surface engineering or for surface modification. This ion trap is suitable to be connected with any separation system, collision cell, ion optics or detector in order to accomplish two-dimensional analysis.

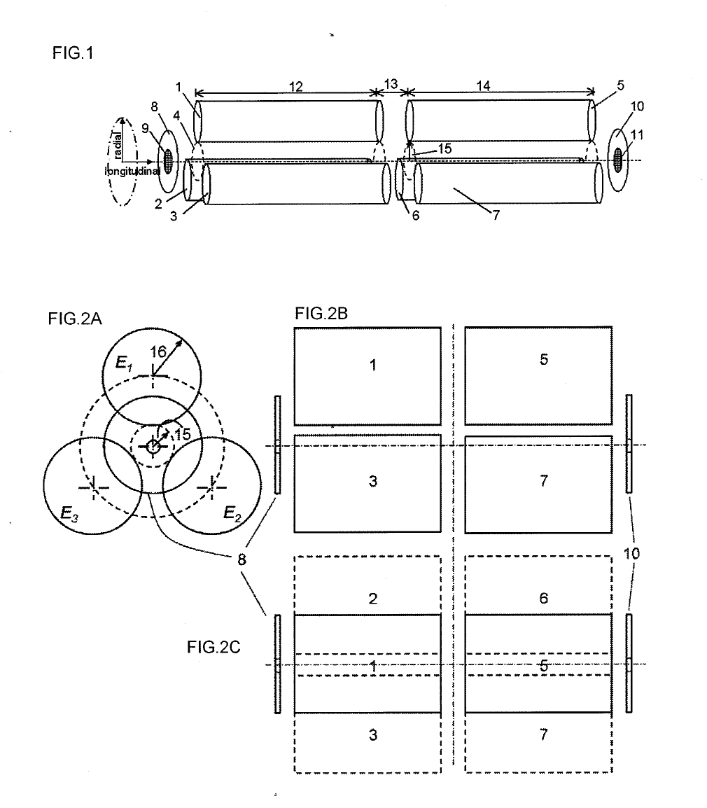

A preferred tripole linear ion trap with a gap will now be described in relation to FIG. 1. In this embodiment, the trap consists of two tripole ion guides separated by a gap. Each tripole ion guide consists of three rod electrodes (1, 2, 3, 5, 6 and 7) with length of 25 mm (12, 14). The electrode rods are radially and symmetrically positioned around a field space of radius r₀ (15). An entrance (8) and exit (10) aperture plates, with hole radius (9, 11) around 2-3 mm and covered with grid, are set at each end of the longitudinal axis. A field space of radius r₀ at the entrance edge (4) can be equal to or different from a field space of radius r₀ at the edge of the gap (13). In this particular example, the length of the gap (13) is equal to a field space of radius r₀ (15) and the size of the rod electrode radius rₑ (16) is 2.2 times the size of the field radius (15), where (15) and (16) are shown in FIG. 2A.

FIGS. 2B and 2C illustrate a side view and an upper view of a tripole linear ion trap with a gap. An entrance (8) and exit (10) aperture plates are positioned on the longitudinal center axis of the ion trap.

FIGS. 3A-3D illustrate embodiments of the claimed invention having a different number of electrodes around the center axis. In the case of n=4, 5, 7 and 8 are shown in the figures. The electrodes are symmetrically positioned at the angular positions (θ), where θ_{E}=2π(E−1)/n radian is determined with the central axis as the origin. The rod electrodes carry (“n”) number of RF voltages with delayed phase. The phase shift of each rod electrode is calculated by φ_{E}=2π(E−1)/n radian and the phase shift between two consecutive rods becomes the symmetric value of 2π/n. The phase shift between two consecutive rods can range from 0 to 2π, more preferably from 0 to 5 times and most preferably from 0.1 to 2 times the value of 2π/n radians. FIG. 3E-F illustrate a cross section view of the scheme of the trap when the positioning of one guide is rotated relative to the other guide. The dotted circle represents the rods (E′) in one guide and the closed line represents the rods (E) in the other guide. FIG. 3E illustrates a trap with one guide (n′=3) is rotated 60 degrees relative to the other guide (n=3). FIG. 3F illustrates a trap where both guides have different number of rods, wherein one guide (n=3) is rotated 60 degrees relative to the other guide (n′=4).

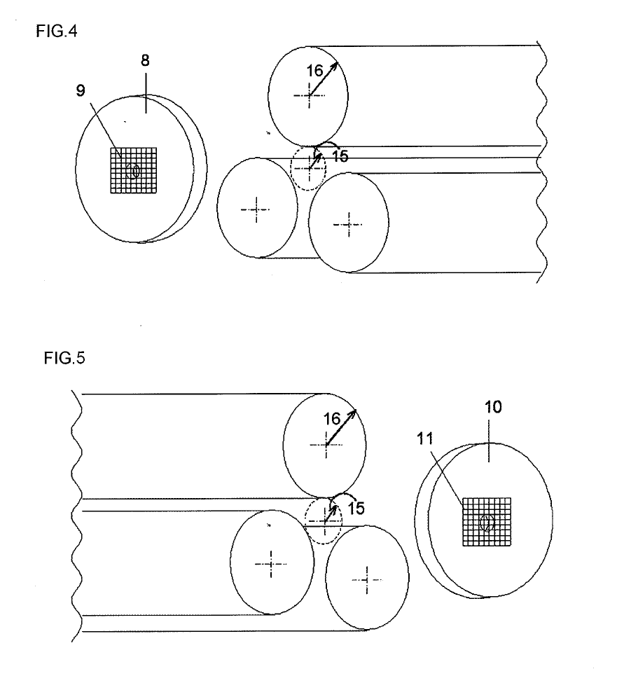

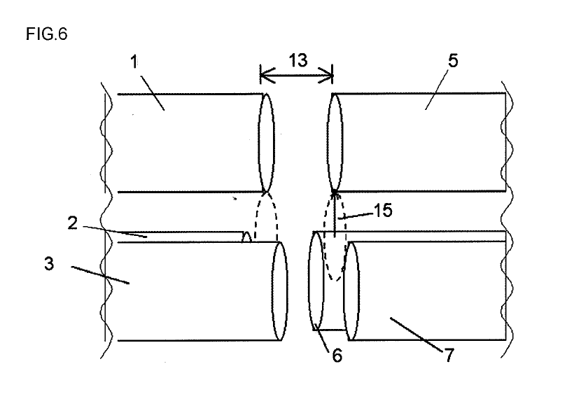

FIGS. 4 and 5 illustrate an entrance end and an exit end of the tripole linear ion trap, respectively. An entrance (8) and exit (10) aperture plates are covered with grids (9, 11).

FIG. 6 illustrates a gap (13) between two ion guides. Gap (13) has substantially the same distance between the electrodes (1 and 5, 3 and 7, and 2 and 6) adjoining in a longitudinal direction.

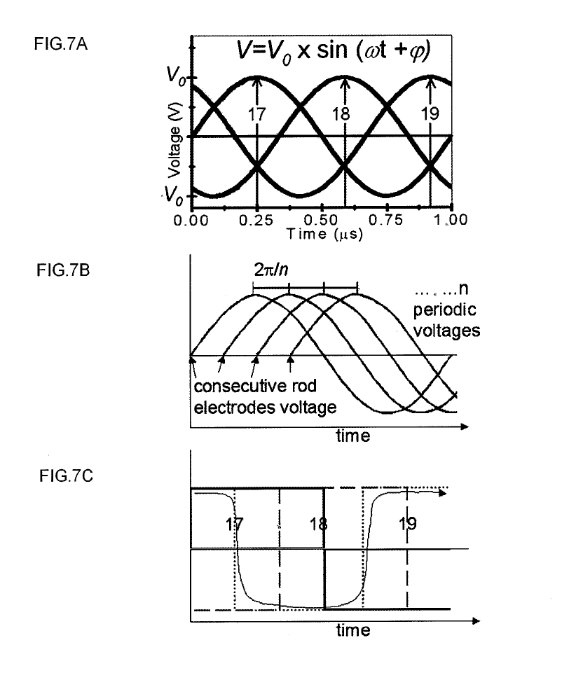

In FIG. 7A and 7C, three AC or RF or square voltages (17, 18, 19) are applied to each rod electrode of each tripole guide. The RF voltages have the same amplitude but their phase shifts are symmetrically delayed. FIG. 7B shows RF voltages applied to rod electrodes where each ion guide having the “n” number of electrodes. The special RF voltages create a rotational RF electric field and then the ions get stable rotations and oscillations (20) in the field space as shown in FIG. 8. Correspondent electrodes are the electrodes located in different tripole guide but containing the same AC voltage phase shift (1 and 6, 2 and 7, 3 and 5, for example).

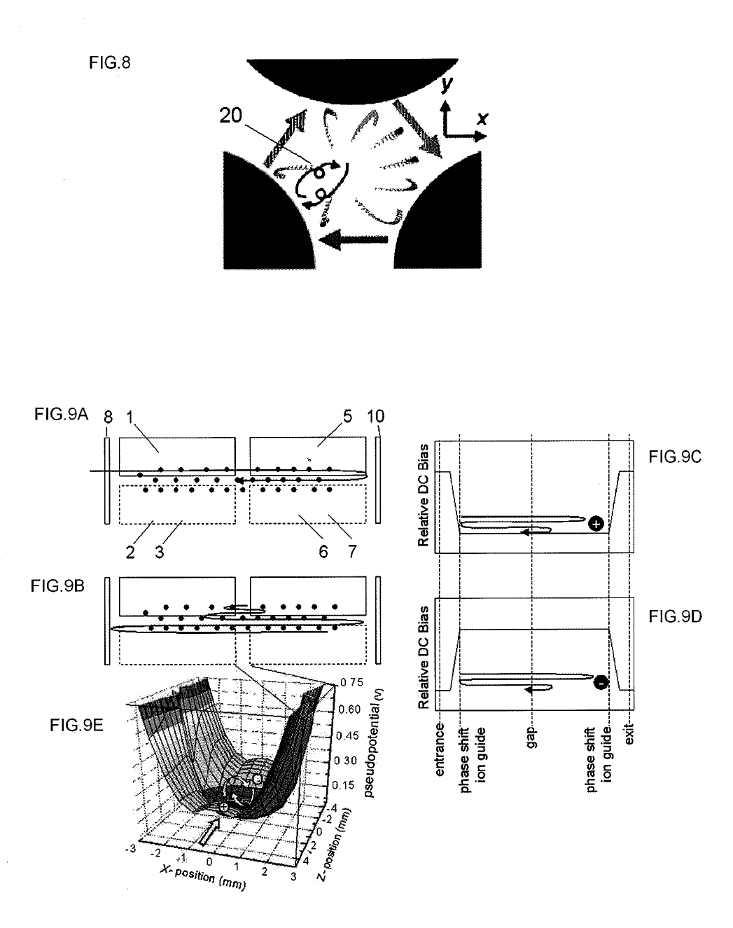

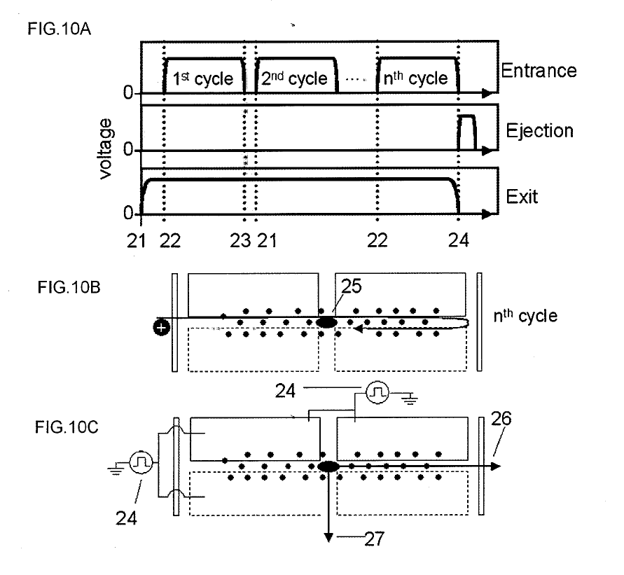

The injection process, shown in FIGS. 9A-9E and 10A-10C, starts when the voltage of the entrance aperture (8) is ground or equal to the ion guides DC offset at the initial time (21) where the ions can enter in the trap. At the same time, the voltage of the exit aperture relative to the ion guide (10) is pulsed. The polarity of the exit voltage is preferably about equal to the ion polarity so that the ions are reflected back. After a certain time around 10 microseconds (22), the voltage of the entrance aperture plate is pulsed similar to the exit aperture plate. As a result, the ions are linearly trapped.

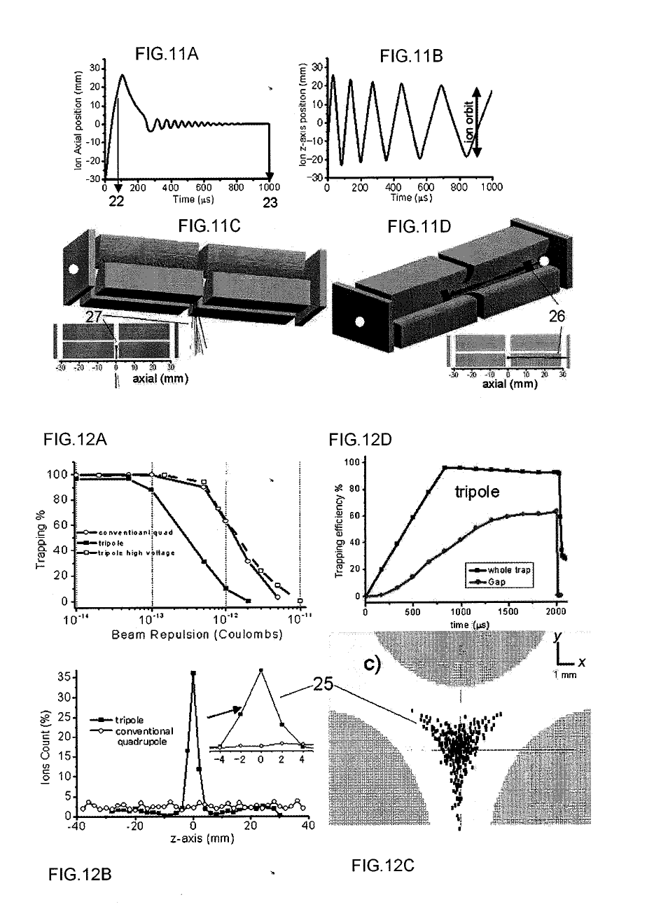

When the ions are inside of the trap, their kinetic energy is damped by collisions with neutral and inert gas like nitrogen, helium or argon; then the ions can be trapped by the pseudopotential in the gap space (FIG. 9E). Computer simulation of the gap trapping process is shown in FIGS. 11A and 11B. After 200 microseconds the ions are compacted in the tripole gap. In contrast, with the conventional quadrupole LIT, the ions are not compacted in the gap after 1,000 microseconds as shown in FIG. 11B. Defining as conventional quadrupole and multipoles as such multipoles with consecutive rods feed with opposite RF voltage. In the ion trap of the claimed invention, after hundreds of microseconds (23) the entrance voltage may be pulsed again and more ions can enter. If the positive and negative linear trapping modes are consecutively used, both kinds of ions can be trapped.

The accumulation process consists of at least one trapping cycle. The cycle can be repeated during a few milliseconds to highly concentrate the analyte in an ion cloud (25). When the accumulation time is reached, an ejecting voltage (24) is pulsed to certain electrodes. When the pulse is applied to one tripole guide (electrodes 1, 2, and 3, for example), the ions are ejected longitudinally (26), as is shown in FIG. 10C and 11D. On the other hand, if the ejecting voltage is applied to electrodes with the same angular position (1 and 5, 2 and 6, or 3 and 7) then the ions are ejected in the direction perpendicular to the longitudinal axis (27). Better focusing can be obtained if the pulse voltage (24) applied to the orthogonal pushing electrodes (1, 5) is higher than the magnitude of the pulse voltage applied to the other electrodes (2, 3, 6, 7).

FIG. 12A shows the computer simulation results of trapping capacity as a function of the beam concentration and space-charge repulsion. When the tripole RF voltage is increased, the tripole with a gap can have a similar trapping capacity to the conventional quadrupole LIT trapping capacity. FIGS. 12B-12C show that the ions are accumulated and compacted in the gap space, defining an ion cloud in a tripole RF rotating trap. FIG. 12D shows the amount of ions (percentage of the total injected ions) in the whole tripole trap and a percentage of ions in the gap as a function of time. A sharp decrease of ions was observed when an ejection was made after 2,000 microseconds.

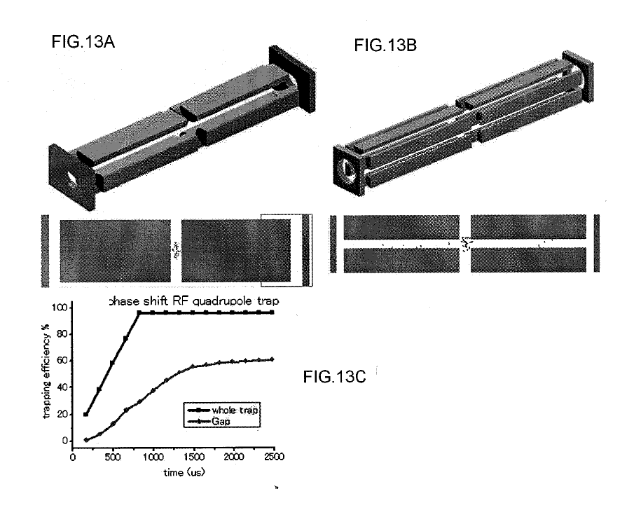

FIGS. 13A and 13B show the computer simulation of the gap trapping in a quadrupole and a hexapole RF rotating traps. FIG. 13C is the same as FIG. 12D except that FIG. 13C shows a quadrupole phase shift RF trap. FIG. 13C shows a percentage of ions in the whole quadruple trap and a percentage of ions in the gap as a function of time. The results show that the trapping efficiency of the quadruple is comparable to the results from the tripole with a gap shown in FIG. 12D.

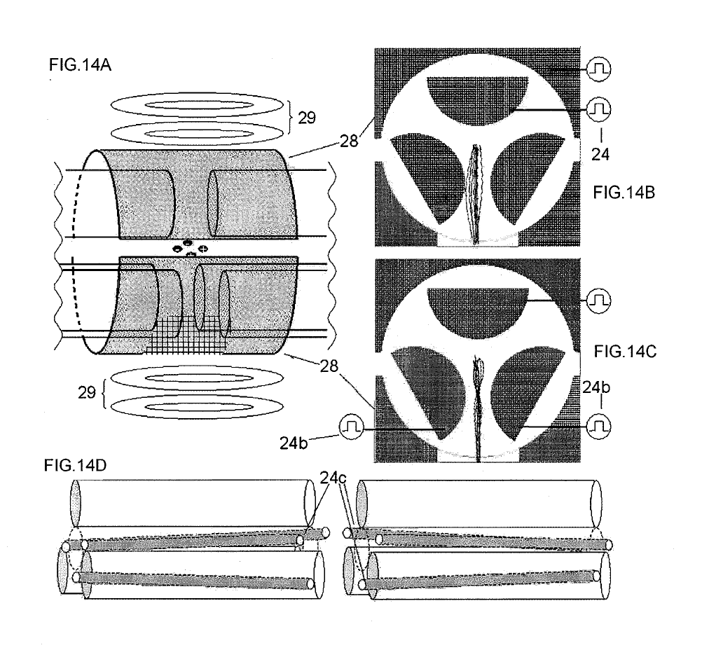

FIG. 14A shows that additional electrodes with cylindrical symmetry (28) to which DC voltage is applied in order to avoid ion losses in the radial direction and help the gap trapping process. Also, additional electrodes (29) set over the ejection axis may be provided which is useful to extract and focus the ejected beam. FIG. 14B is the computer simulation of the ejection process when pulse voltage is applied to the electrode rod opposite to the ejection trajectory. FIG. 14C is the same but pulse voltage, lower in magnitude, is applied to the other rods (24b) in order to get a second focusing point. FIG. 14D shows a perspective view of the ion trap having additional electrodes of wires at angular positions intercalated between each of the phase shift RF rods. The wires can have any azimuthal and elevation angle and shape symmetric or tapered.

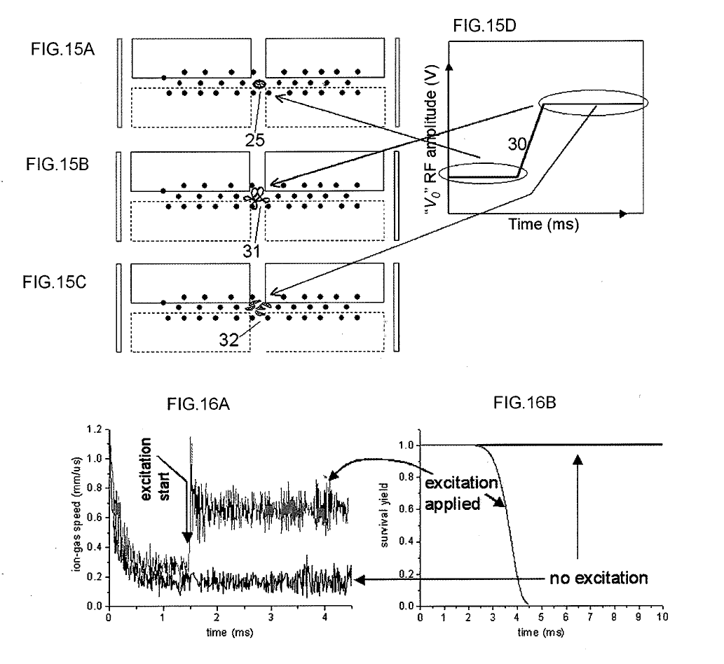

FIGS. 15A-15D show that the trapped ions oscillating at low RF amplitude, when the RF amplitude is increased (30) the ions oscillating amplitude and speed increase (31), and the ion-gas particles collision number and energy increase. As a result, the ions become excited and fragmented (32).

FIGS. 16A-16B shows the computer simulations results of ion speed and ion precursor survival yield with and without RF amplitude excitation. FIG. 16B shows that the survival yield sharply decreases as the excitation is applied.

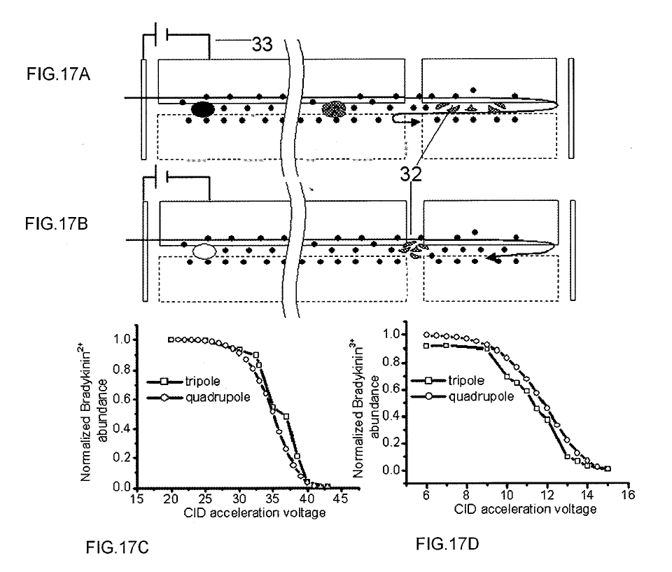

FIGS. 17A-B show that the tripole trap can be used as a CID collisional cell in which ions are accelerated by a DC voltage (33) and the fragments are accumulated in the gap. As shown in FIGS. 17A and 17B, the electrode axial lengths in the different guides do not necessarily have the same length. FIGS. 17C-D show the normalized survival yield in the CID fragmentation of bradykinin²⁺ and bradykinin³⁺ with a tripole and a quadrupole having similar size, gap and voltage. The results show that the fragmentation with the tripole is comparable to the fragmentation with the quadrupole.

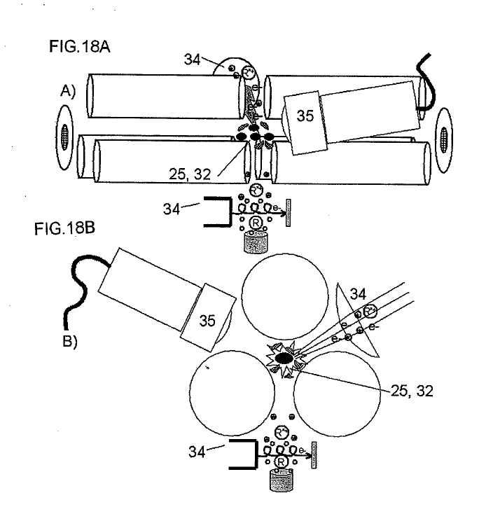

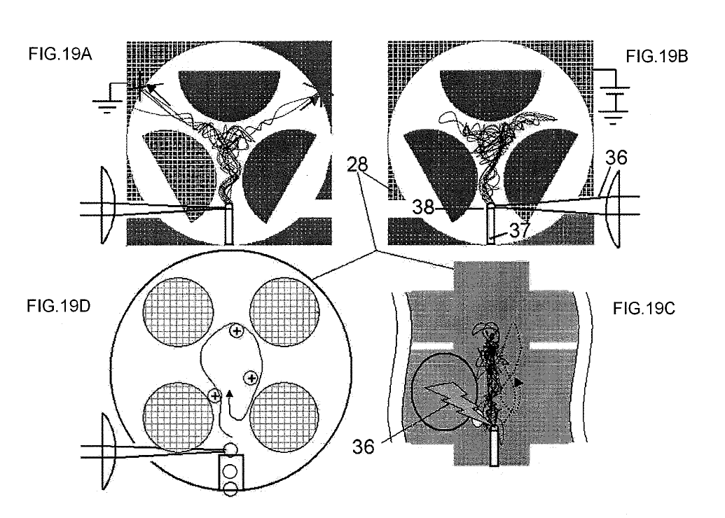

FIGS. 18A-18B show that a trapped ion or ions can be illuminated, camera visualized (35) and fragmented by any kind of photon excitation method (34) or by particle-particle reaction such as ECD, ETD; “in-trap” EI and “ in-trap” CI which are carried out when the trapped ions are irradiated with electron beams or ionised particles generated by a glow-discharge needle or a electron source, set near the gap (34). The claimed ion trap is suitable for an application as shown in FIG. 18A-18B because the ions are compacted in the gap.

FIGS. 19A-19D show that the sample (38) mounted in a stage like tip (37) or introduced through a pipe can be internally ionised by any desorption/ionisation method (36) such as laser, photon etc. As shown in FIGS. 19A and 19B, if an additional cylindrically symmetric electrode (28) surrounds the system and carries a DC voltage to move and keep the ions inside the field space, the ions can be trapped more efficiently. The RF 3D field is weak between the electrodes but the DC voltage pushes back the ions.

A sample drop or piece may be loaded on an electrically non conductive sample stage (tip shape). The sample stage is preferably set in the longitudinal center of the gap space or may be set at any other longitudinal position. The sample drop radial position from the center axis is preferably from 0% to 500% of the sum of the field and electrode radius (r₀+rₑ), more preferably 50% to 300% of the sum of the field and electrode radius (r₀+rₑ), and most preferably 75% to 200% of the sum of the field and electrode radius (r₀+rₑ). However, the sample drop radial position radius position should be lower than the radial position of the additional electrodes. The sample drop can be internally or semi-internally ionised by any desorption-ablation ionisation method as laser desorption methods, matrix assisted laser desorption/ionization (MALDI), desorption electrospray ionization (DESI), direct analysis in real time (DART), electron, atom or ion beam, etc. The sample externally ionised may be flowed through a non conductive tube or capillary inserted through the additional electrodes and positioned similarly as the tip-shape sample stage. A neutral gas sample flowed through the tube can be internally ionised. Then the ions orthogonally enter in the gap space or at any other longitudinal position and get trapped due to the RF and DC field applied by the ion trap and the additional electrodes.

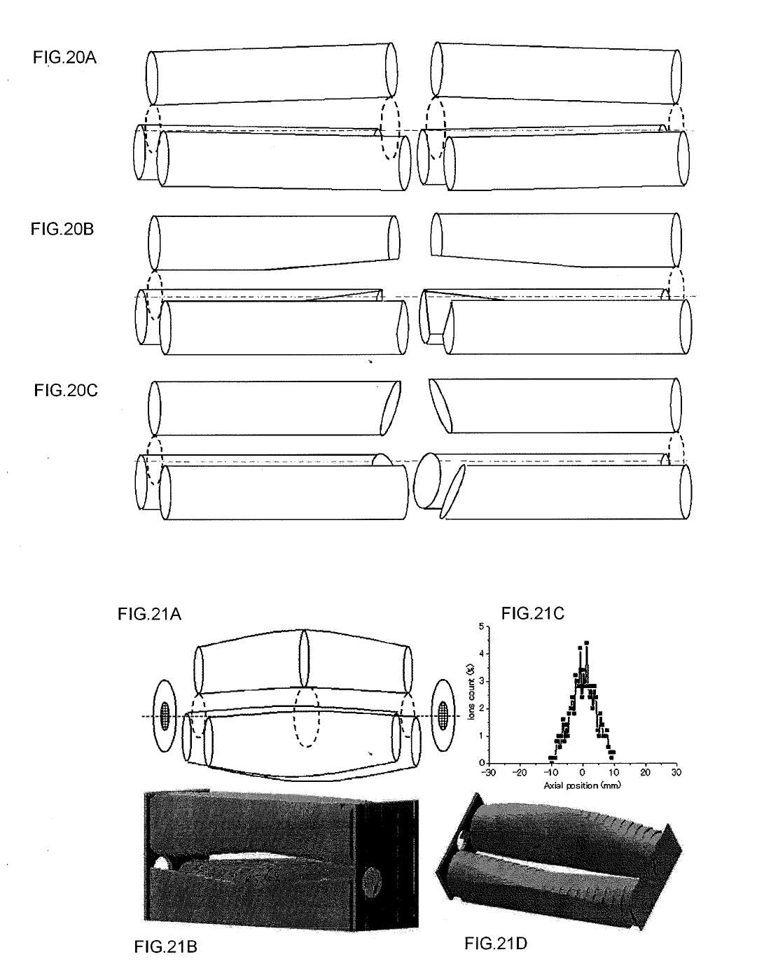

FIGS. 20A-20C show various configurations of the electrodes such as non parallel (tilted) trap rods and rods with angle cut near the gap space. These configurations push the ions toward the gap center. The claimed invention includes but is not limited to the embodiments shown in FIGS. 20A-20C.

FIG. 21A shows another embodiment of the present invention. In this embodiment, the ion trap comprises a phase-shifted RF guide having three or more electrodes, an entrance ion optics, an exit ion optics, and a voltage supply to feed the electrodes with an RF voltage. The ion trap has only one ion guide but is provided with a larger field space in the middle portion of the electrodes in the longitudinal direction. A trap center is located between the longitudinal ends of the trap. Although FIGS. 21A, 21B and 21D show the rods in oval, the rod can be in any other shapes. As shown in FIG. 21C, ions are trapped in the field space near where the field radius is largest. The field radius decreases linearly or non-linearly and forming a funnel shape from the trap center to the longitudinal end. The rod width changes with the field radius. The funnel-shaped RF field pushes the ions to the trap center because the pseudopotential far from the center is stronger.

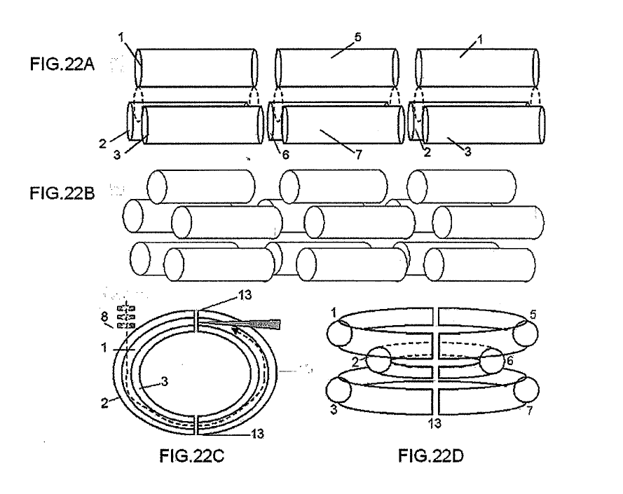

FIGS. 22A and 22B show another embodiment of the present invention. In this embodiment, the ion trap comprises a segmented phase shift RF trap. The ions can be trapped in the gap and in the central segment. The same electrodes used in FIG. 1 may be used for this embodiment. FIG. 22C-22D shows an upper view and a perspective view of a ring-shape RF rotating trap. The ions tangentially enter (discontinuous arrow) into the trap and the ions may be irradiated by a laser. The entrance and exit optics are rearranged and the multipole can be bent in circular, oval, rectangular, or any other continual shape that joins the entrance and exit edges. One or more gaps can be made at any point of the ring-shaped trap.

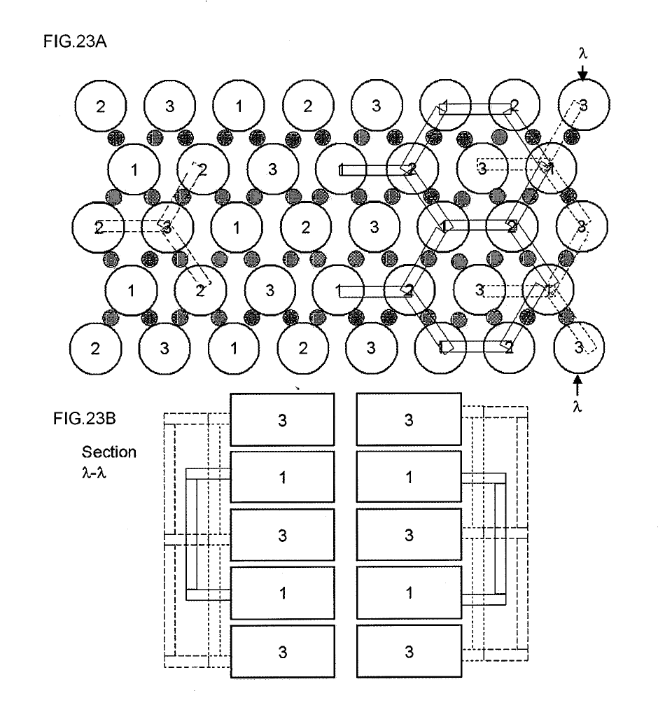

FIGS. 23A and 23B show another embodiment of the present invention. An ion trap can be miniaturized by decreasing the electrodes sizes. The miniature ion trap may comprise one or more micropole arrays separated with the gap and with the phase delay RF voltages and means to set a wire network to feed the micropole array with the RF voltage. The RF voltage is supplied through a wire network overlapped for the poles. A tripole array is shown in the figures as an example. Needless to say, the present invention includes but not limited to a tripole array. The miniature electrodes can be micro layers or any other shape made by any lithography, micro-processing, micro-electrochemical, micro-surface engineering or micro-machining method.

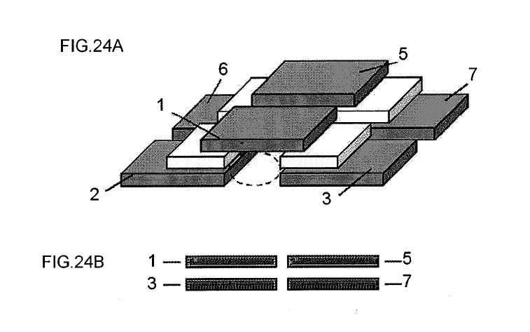

FIG. 24A shows another embodiment of the present invention. There is a trend in miniature ion traps for portable and in-situ analysers. In this embodiment, the ion trap comprises a miniaturized RF phase shift trap of a planar symmetry tripole. The electrodes may be made of stacked micro size conducting layers and separated by insulators. FIG. 24B shows a side view of the planar symmetry RF rotating trap.

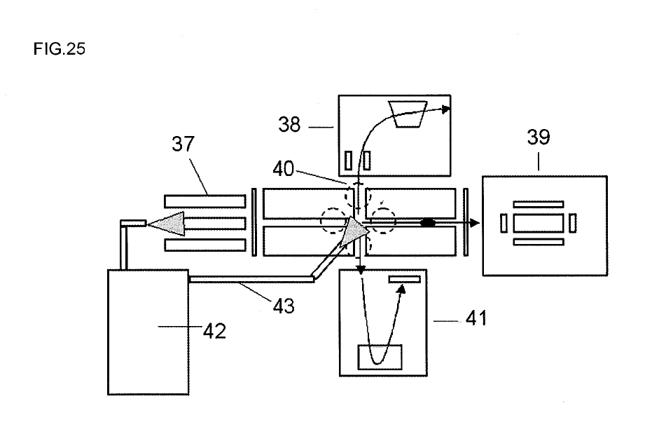

FIG. 25 shows an example application of the ion trap. The ion trap can be coupled to one or more devices such as: an ion source, or a primary or post ion optics, or a separation device in order to do complementary, tandem analysis or two- dimensional separations. The ion optics may be a DC, an RF multipole, a magnetic system, a collision cell, a time of flight (TOF), an ion cyclotron resonance (ICR), an ion trap or a combination of the foregoing etc. The separation apparatus can be any kind of a mass spectrometer, an ion mobility spectrometer for 2D separation or fragment analysis, a gas chromatograph, a liquid chromatograph, a supercritical fluid chromatograph, a capillary electrophoresis device or a combination of the foregoing etc. The ion source may be an ioniser device, a sample stage, a gas tank, or a combination of the foregoing etc. In FIG. 25, the ion trap is connected to other mass analysers, collision cell and other ion optics like quadrupole (37, 40), magnetic sector (38), ICR cell (39), TOF (41). Also, the ion trap is connected to any ion source (43) coming from other separation techniques or gas vessel (42) like HPLC, electrophoresis, ion mobility, gas chromatograph etc. The ion trap can be useful for mass spectrometry and beam physics, specifically for high efficient ion accumulation and focusing the ions in a small space.

Although all possible variations are not listed herein, the present invention can be embodied in any modes incorporating various changes, modifications and improvements based on the knowledge of those skilled in the art. It goes without saying that these embodiments are also included in the scope of the present invention, as long as they do not deviate from the purpose of the present invention.

What is claimed is:

1. An radio frequency (RF) ion trap comprising:
at least two RF ion guides separated by a gap, each of said ion guides comprising at least three or more electrodes positioned around a field space; and
a voltage supply adapted to apply each of the electrodes with phase-delayed RF voltage that traps an electrically charged particle in the ion trap.

2. The radio frequency (RF) ion trap of claim 1 further comprising:
entrance ion optics located at one end of the ion trap;
exit ion optics located at another end of the ion trap; and
a voltage supply to feed said entrance ion optics and said exit ion optics;
wherein the electrodes are positioned around a central axis of the ion trap.

3. The RF ion trap of claim 2, wherein the voltage supply is adapted to feed the entrance ion optics and the exit ion optics with a voltage so as to create a pulsed electric field in a way that the electrically charged particle can pass through the entrance ion optics and become longitudinally trapped in the ion trap.

4. The RF ion trap of claim 1, wherein the voltage supply is adapted to feed specific electrode(s) with a voltage so as to create a pulsed electric field that ejects the electrically charged particle contained in the ion trap.

5. The RF ion trap of claim 2, wherein said electrodes are in a rod shape and each of said electrodes is longitudinally symmetrical, and an equal or unequal number of the electrodes are in each of the ion guides.

6. The RF ion trap of claim 2, wherein said electrodes are radially mounted with the central axis as the origin, the symmetric angular position (0) of said electrodes is set by θ_{E}=2π/(E−1)/n radians, where “n” is the number of the electrodes in each of the ion guide, and “E” is an electrode consecutive number from “1” to “n”; or the angular position is asymmetric.

7. The RF ion trap of claim 5, wherein cross section of each rod electrode is in a geometrical shape and a half of rod width value is between 1 to 4 times of a field radius, wherein the half of rod width is a maximum distance from one periphery point to a symmetry center in the cross section of the rod perpendicular to a longitudinal direction, and the field radius is a minimum distance from the central axis to an electrode surface.

8. The RF ion trap of claim 2, wherein said electrodes are positioned parallel or at an angle relative to the central axis.

9. The RF ion trap of claim 1 wherein an electrode RF voltage shape is a periodic electric voltage of sinusoidal, square, or pulse; symmetric phase shift of each RF voltage is calculated by φ_{E}=2π(E−1)/n radians where the phase shift between two consecutive rods is 2π/n radians; an RF voltage amplitude and/or a frequency applied to the electrodes is substantially equal between the ion guides; when asymmetric phase shift is used, the difference between two consecutive rods is in a range of 0 to 2π radians.

10. The RF ion trap of claim 2 wherein the voltage applied to said entrance ion optics and exit ion optics is ground, DC, square, sinusoidal or a combination of the foregoing in order that the electrically charged particle can enter and become linearly or longitudinally trapped inside of said ion guides, and said gap length is in a range greater than 0% and 500% or less of the field radius.

11. The RF ion trap of claim 1 wherein said RF voltage is capable of creating a three-dimensional trapping field or a pseudopotential well in the gap space, wherein said gap space is a longitudinal space between the phase shift RF guides, thereby the electrically charged particle becomes focused in said gap space.

12. A method for colliding ions using the RF ion trap of claim 1 comprising the steps of:
pressurizing said ion trap with a gas,
introducing an ion into the ion trap,
accelerating the ion through said RF ion trap by means of electric potential, and colliding the ion with the gas particles,
wherein said RF ion trap is used as a collision cell or a focusing cell.

13. The method for colliding the ions according to claim 12 further comprising the step of:
raising the amplitude of the RF voltage of said ion trap to increase the speed and movement amplitude of the trapped ions, and a collision induced dissociation increases, thereby resulting in fragmentation of the ions by RF excitation, wherein said RF ion trap is used as dissociation cell.

14. The RF ion trap of claim 1 further comprising:
a device for making the trapped electrically charged particle illuminated or excited for visualization by UV, IR, electromagnetic irradiation energy, temperature increase, or a combination of foregoing.

15. The RF ion trap of claim 1, further comprising:
a device for detecting, visualizing and/or observing the trapped electrically charged particle.

16. The RF ion trap of claim 1, further comprising:
a device for fragmenting the trapped electrically charged particle by electromagnetic irradiating energy, electron, atom, ion beam, temperature increase, or a fragmentation technique of IRMPD, or BIRD; or by particle-particle reaction such as ECD, ETD,“in-trap” EI and “in-trap” CI.

17. An analytical instrument comprising:
the RF ion trap of claim 1 coupled to one or more devices selected from the group consisting of an ion source, an ion optics, and a separation device in order to perform complementary, tandem analysis or two-dimensional separations;
wherein said ion optics is a DC, an RF multipole, a magnetic system, a collision cell, a TOF, an ICR, an ion trap, or a combination of the foregoing;
wherein said separation device is any kind of mass spectrometer, an ion mobility spectrometer, a chromatograph, a capillary electrophoresis device or a combination of foregoing;
wherein said ion source is an ioniser device, a sample stage, a gas tank, or a combination of foregoing.

18. The RF ion trap of claim 1 further comprising:
a ring-shaped pick-up electrode, a tube-shaped pick-up electrode, or a coil,
wherein oscillations of the electrically charged particle trapped in the gap is inductively sensed.

19. The RF ion trap of claim 2 wherein the voltage supply has a trapping mode switching mechanism, wherein a positive mode is when the entrance ion optics and the exit ion optics are suitable to trap positively charged particle and a negative mode is a vice verse situation;
thereby said positively charged particle and the negatively charged particle can be trapped together when one of the trapping modes is used after the other mode.

20. The RF ion trap of claim 1 wherein the voltage supply has a capability of applying a pulsed bias voltage to all the electrodes of only one or more ion guides to longitudinally eject the trapped electrically charged particle from the ion trap.

21. The RF ion trap of claim 1 wherein the voltage supply has a capability of applying a voltage to one or more phase shift RF electrode(s) in different ion guides so as to eject the trapped electrically charged particle from the ion trap in an orthogonal direction with respect to the center axis, and wherein a negatively charged particle and a positively charged particle are ejected in opposite directions.

22. The RF ion trap of claim 1 wherein the voltage supply has capability of applying a lower magnitude pulse voltage to non-pushing rods to keep ejected ion beam focused.

23. The RF ion trap of claim 1 further comprising:
one or more additional electrode(s) or aperture plate(s),
wherein the additional electrode(s) helps containing the electrically charged particle in a field space when DC voltage of the same polarity of the electrically charged particle is applied to the additional electrode(s), and
the additional electrode(s) help extracting and keeping ejected electrically charged particle collimated when D,C voltage of opposite polarity of the electrically charged particle is applied to the additional electrode(s).

24. The RF ion trap of claim 23 wherein the additional electrode(s) is in a substantially cylindrical shape and positioned partially or completely surrounding the gap, and wherein an axial length of the additional electrode is greater than 0% but 100% or less of the ion trap length.

25. The RF ion trap of claim 23 wherein the additional electrode(s) is wire(s), wherein the wire(s) is positioned at an angular position intercalated between the phase shift RF electrodes.

26. The RF ion trap of claim 23 further comprising:
an electrically non-conductive sample stage (tip shape) for placing a sample drop or solid piece of a sample in the ion trap, the sample drop radial position from the center axis is in a range of 0% to 500% of a sum of a field radius and an electrode radius (r₀+rₑ) but lower than a radial position of the additional electrodes,
wherein the field radius is a minimum distance from the central axis to the electrode surface, and the electrode radius is a maximum distance from one periphery point to a symmetry center in a cross section of the electrode,
thereby said sample drop can be internally or semi-internally ionised by a desorption-ablation ionisation method of laser desorption methods, MALDI, DESI, DART, electron, atom or ion beam.

27. The RF ion trap of claim 23 further comprising:
an electrically non-conductive tube or a capillary for introducing a sample into the ion trap,
thereby the sample externally ionised can be introduced through the non-conductive tube or the capillary into the ion trap; alternatively a neutral gas sample introduced through the tube can be internally ionised.

28. A radio frequency (RF) ion trap comprising:
three or more electrodes positioned around a central axis; and
at least one voltage supply to feed said electrodes with an RF voltage;
wherein a field radius decreases from a trap center to longitudinal ends of the ion trap in a longitudinal direction where the trap center is located between the longitudinal ends of the ion trap,
thereby an RF field pushes electrically charged particle to a trap center because the pseudopotential far from the center is stronger.

29. The radio frequency (RF) ion trap of claim 1, wherein the ion guides have a shape to constitute a continual circular-shaped trap, an continual oval-shaped trap, or a continual rectangular-shaped trap.

30. The RF ion trap of claim 1 further comprising:
the ion guides that are micropole arrays separated with said gap; and
a wire network to feed said micropole array with said RF voltage;
wherein the micropole arrays are micro layers or a shape made by lithography, micro-processing, micro-electrochemical, micro-surface engineering or micro-machining method.
